(19) United States
(12) Patent Application Publication
(10) Pub. No.: US 2022/0288855 A1
(43) Pub. Date: Sep. 15, 2022

(54) ADDITIVE MANUFACTURING SYSTEM WITH LOCALIZED CONTROLLED ENVIRONMENT

(71) Applicant: Nikon Corporation, Tokyo (JP)

(72) Inventors: Alton Hugh Phillips, Oro Valley, AZ (US); Michael Birk Binnard, Belmont, CA (US); Takakuni Goto, Saitama (JP); Paul Derek Coon, Redwood City, CA (US); Motofusa Ishikawa, Ageo-shi (JP); Daniel Gene Smith, Tucson, AZ (US)

(21) Appl. No.: 17/686,303

(22) Filed: Mar. 3, 2022

Related U.S. Application Data
(60) Provisional application No. 63/159,367, filed on Mar. 10, 2021.

(51) Int. Cl. B29C 64/371; B29C 64/147; B29C 64/153; B29C 64/232; B29C 64/268

(52) U.S. Cl. CPC B29C 64/371; B29C 64/147; B29C 64/153; B29C 64/232; B29C 64/268; B33Y 10/00

(57) ABSTRACT

A processing machine (10) for building an object (11) from material (12) includes (i) a material bed assembly (16) that supports the material (12); (ii) a material supply assembly (18) that positions the material (12); (iii) an energy system (22) that directs an energy beam (22A) at the material (12) to build the object (11); (iv) a housing assembly (24) that defines at least a portion of a build chamber (29) for the energy beam (22A), the housing assembly (24) being spaced apart a housing gap (30A) from the material (12); and (v) a seal assembly (26) that creates a housing seal (26A) between the housing assembly (24) and the material (12) to seal the housing gap (30A).

### RELATED APPLICATIONS

This application claims priority on U.S. Provisional Application No. 63/159,367 filed on Mar. 10, 2021, and entitled “ADDITIVE MANUFACTURING SYSTEM WITH LOCALIZED CONTROLLED ENVIRONMENT”. As far as permitted the contents of U.S. Provisional Application No. 63/159,367 are incorporated in their entirety herein by reference.

### BACKGROUND

Three-dimensional printing systems are used to print three-dimensional objects. Existing three-dimensional printing systems are relatively slow, have a low throughput, are expensive to operate, and/or generate excessive waste. There is a never ending search to increase the speed, increase the throughput, and reduce the cost of operation for three-dimensional printing systems.

### SUMMARY

The present implementation is directed to a processing machine for building a three-dimensional object from a material. The processing machine can include (i) a material bed assembly that supports the material during building of the object; (ii) a material supply assembly that positions the material; (iii) an energy system that directs an energy beam at the material to build a portion of the object on the material bed assembly; (iv) a housing assembly that defines at least a portion of a build chamber for the energy beam; and (v) an environmental control assembly that creates a localized controlled environment in the build chamber for the energy beam.

In one implementation, the housing assembly is spaced apart a housing gap from at least one of the material and the material bed assembly. Further, a seal assembly can be used to create a housing seal between the housing assembly and the material to seal the housing gap.

With the present design, the processing machine utilizes a localized controlled environment (e.g., a localized vacuum environment or an inert atmosphere) for the energy beam to travel from the energy system to the material. As a result thereof, many of the other components of the processing machine can be positioned outside of the build chamber.

For example, the housing seal can be a leaky seal. Further, the seal assembly can include a seal environmental controller that controls a housing gap environment in the housing gap. The housing gap environment can be controlled to be the same as the environment in the build chamber.

The material supply assembly can supply a sheet of material to the material bed assembly. In one implementation, the material supply assembly includes a supply reel that initially retains the sheet of material, and a return reel. In this design, movement of the supply reel causes the sheet of material to move above the material bed assembly to the return reel.

The energy system can direct the energy beam at the material above the material bed assembly to cut and melt the sheet of material.

Additionally, a cutting system can be used to cut out one or more passageways in the sheet of material prior to this portion of the sheet of material being positioned in the build chamber.

In another implementation, the material supply assembly deposits a powder layer of powder onto the material bed assembly.

Moreover, a thermal control system can be used to sinter the powder prior to the powder being positioned in the build chamber. The thermal control system can be positioned outside the build chamber.

In another implementation, the present invention is directed to a method including: supporting the material with a material bed assembly during building of the object; positioning the material with a material supply assembly; directing an energy beam at the material to build a portion of the object on the material bed assembly with an energy system; providing a build chamber for the energy beam with a housing assembly; and creating a localized controlled environment in the build chamber for the energy beam with an environmental control assembly.

### BRIEF DESCRIPTION OF THE DRAWINGS

The novel features of this embodiment, as well as the embodiment itself, both as to its structure and its operation, will be best understood from the accompanying drawings, taken in conjunction with the accompanying description, in which similar reference characters refer to similar parts, and in which:

FIG. 1A is a simplified, cut-away view of an implementation of a processing machine;

FIG. 1B is a simplified top view of a portion of a material used in the processing machine of FIG. 1A;

FIG. 1C is a bottom view of a housing assembly from FIG. 1A;

FIG. 1D is a top view of a material bed assembly from FIG. 1A;

FIG. 2A is a perspective view of a portion of another implementation of the processing machine;

FIG. 2B is a top view of the portion of the processing machine of FIG. 2A;

FIG. 2C is a cut-away view taken on line 2C-2C in FIG. 2A;

FIG. 3A is a simplified, cut-away view of another implementation of a processing machine;

FIG. 3B is a simplified top view of a portion of a sheet of material;

FIG. 4 is a simplified, cut-away view of still another implementation of a processing machine;

FIG. 5A is a simplified, cut-away view of yet another implementation of a processing machine at a first position;

FIG. 5B is a simplified, cut-away view of yet another implementation of a processing machine at a first position; and

FIG. 6 is a simplified, cut-away view of still another implementation of a processing machine.

### DESCRIPTION

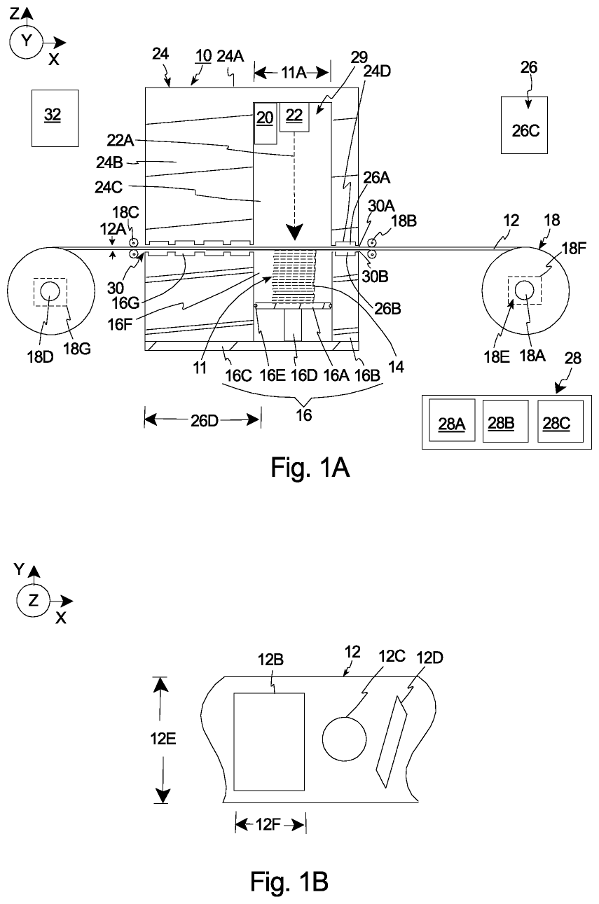

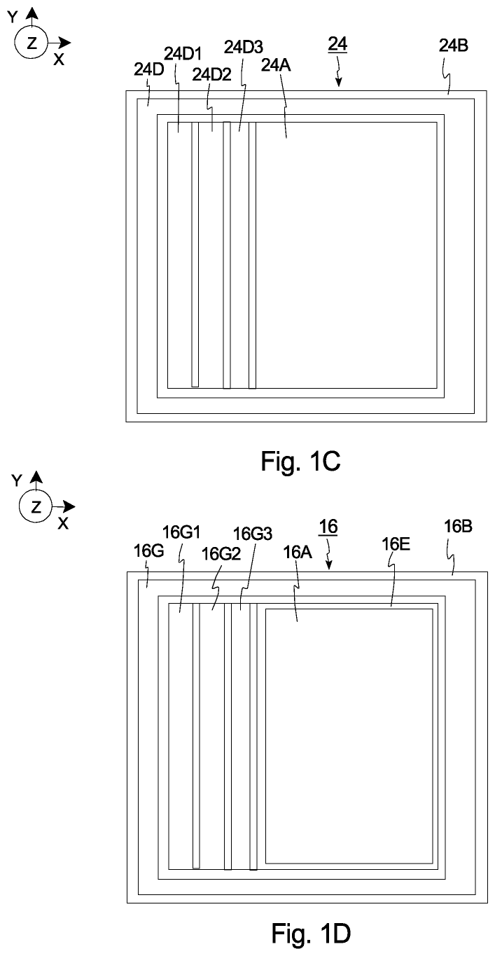

FIG. 1A is a simplified side illustration of a processing machine 10 that may be used to manufacture one or more three-dimensional objects 11 (illustrated as box). As provided herein, the processing machine 10 can be an additive manufacturing system, e.g. a three-dimensional printer, in which a material 12 in a series of material layers 14 (illustrated as dashed boxes) is joined, melted, solidified, and/or fused together to manufacture one or more three-dimensional object(s) 11 (only one is illustrated). The number of objects 11 that may be made concurrently can vary according the type of object 11 and the design of the processing machine 10.

The type of three-dimensional object(s) 11 manufactured with the processing machine 10 may be almost any shape or geometry. The three-dimensional object 11 may also be referred to as a “built part”.

The type of material 12 joined and/or fused together may be varied to suit the desired properties of the object(s) 11. As a non-exclusive example, the material 12 may include metal or alloys (e.g., including one or more of titanium, aluminum, vanadium, chromium, copper, stainless steel, nickel, or other suitable metals) for metal three-dimensional printing. Alternatively, the material 12 may be non-metal, plastic, polymer, glass, ceramic material, organic material, an inorganic material, or any other material.

A number of different designs of the processing machine 10 are provided herein. In certain implementations, the processing machine 10 includes (i) a material bed assembly 16; (ii) a material supply assembly 18; (iii) a measurement device 20 (illustrated as a box); (iv) an energy system 22 (illustrated as a box) that generates an energy beam 22A that is directed at the material 12 above the material bed assembly 16; (v) a housing assembly 24; (vi) a seal assembly 26; and (vii) a control system 28 (illustrated as a box) that cooperate to make each three-dimensional object 11. The design of each of these components may be varied pursuant to the teachings provided herein. Further, the positions of the components of the processing machine 10 may be different than that illustrated in FIG. 1A. Moreover, the processing machine 10 can include more components or fewer components than illustrated in FIG. 1A. For example, the processing machine 10 can include a cooling device (not shown in FIG. 1A) that uses radiation, conduction, and/or convection to cool the material 12.

As an overview, these processing machines 10 disclosed herein accurately, efficiently, and quickly build the object(s) 11. Further, in certain implementations, the processing machines 10 are uniquely designed to utilize a localized controlled environment (e.g. a localized vacuum environment) for the energy beam 22A to travel from the energy system 22 to the material 12. More specifically, the housing assembly 24 can cooperate with the material 12 and/or the material bed assembly 16 to form at least a portion of a build chamber 29 that is used to provide the localized controlled environment. As a result thereof, other components of the processing machine 10 can be positioned outside of the build chamber 29 and will not be required to be in the controlled environment. This will simplify the design of the other components of the processing machines 10.

A number of Figures include an orientation system that illustrates an X axis, a Y axis that is orthogonal to the X axis, and a Z axis that is orthogonal to the X and Y axes. It should be noted that any of these axes can also be referred to as the first, second, and/or third axes.

The material bed assembly 16 supports the material 12 during the forming of the object 11. In the non-exclusive implementation of FIG. 1A, the material bed assembly 16 includes (i) a build platform 16A that supports the material 12 and the object(s) 11 while being formed; (ii) a platform side wall assembly 16B that extends upward around a perimeter of the build platform 16A; (iii) a platform base 16C that supports the platform side wall assembly 16B; and (iv) a platform mover 16D (e.g. one or more actuators) that selectively moves the build platform 16A relative to the platform side wall assembly 16B. In this implementation, the build platform 16A can be moved linearly downward relative to the platform side wall assembly 16B with the platform mover 16D as each subsequent layer 14 is added. Stated in another fashion, the build platform 16A can be moved somewhat similar to a piston relative to the platform side wall assembly 16B which acts like the piston's cylinder wall.

In alternative, non-exclusive implementations, the build platform 16A can be (i) flat, circular disk shaped for use with a corresponding platform side wall assembly 16B that is circular tube shaped; (ii) flat rectangular plate shaped for use with a corresponding platform side wall assembly 16B that is rectangular tube shaped, or (iii) polygonal-shaped for use with a corresponding platform side wall assembly 16B that is polygonal tube shaped. Alternatively, other shapes of the build platform 16A and the platform side wall assembly 16B may be utilized.

Additionally, the material bed assembly 16 can include a platform seal 16E that seals the build platform 16A to the platform side wall assembly 16B, and that allows the build platform 16A to move relative to the platform side wall assembly 16B

The platform mover 16D is controlled by the control system 28 to move the build platform 16A linearly downward as each subsequent layer 14 is added relative to the platform side wall assembly 16B. The platform mover 16D can be an actuator, such as a linear motor, an actuator that rotates a fine pitch thread, or other actuator. For example, the platform mover 16D can move the build platform 16A in a stepped fashion or some other fashion in the direction of gravity.

In this design, the platform mover 16D, the platform base 16C, and a portion of the platform side wall assembly 16B are positioned outside of the localized controlled environment.

The material supply assembly 18 positions the material 12 over the build platform 16A for forming the object 11. The design of the material supply assembly 16 will depend upon the design of the material 12. In the non-exclusive implementation of FIG. 1A, the material 12 is a sheet of metal, and the material supply assembly 18 is somewhat similar to a reel to reel device. In this design, the material supply assembly 18 includes (i) a supply reel 18A; (ii) an input material guide assembly 18B; (iii) an output material guide assembly 18C; (iv) a return (scrap) reel 18D; and (v) a reel mover assembly 18E (illustrated as a box in phantom) that cooperate to position the material 12 on (or above) the build platform 16A.

The supply reel 18A can include an annular shaped hub, and the new, unused material 12 can be initially wound (rolled) around the hub of the supply reel 18A. The material 12 on the supply reel 18A can be referred to as the supply material.

The input guide assembly 18B and the output guide assembly 18C cooperate to guide the movement of the material 12 over the material bed assembly 16. For example, the input guide assembly 18B can include a pair of rollers that are spaced apart a distance that is approximately equal to a material thickness 12A of the material 12, and the output guide assembly 18C can include a pair of rollers that spaced apart a distance that is approximately equal to the material thickness 12A.

The return reel 18D can include an annular shaped hub, and the material 12 that exits from above the material bed assembly 16 can be wound (rolled) around the hub of the return reel 18D. The material 12 on the return reel 18D can be referred to as the return (or used) material.

The reel mover assembly 18E rotates the reels 18A, 18B to move the material from the supply reel 18A to the return reel 18D over the build platform 16A. For example, the reel mover assembly 18E can include a supply mover 18F that selectively rotates the supply reel 18A, and a return mover 18G that selectively rotates the return reel 18D. With this design, the reel mover assembly 18E can be controlled by the control system 28 to position the material 12 above the build platform 16D. In the specific illustration in FIG. 1A, the supply reel 18A is rotated counter-clockwise, and the return reel 18D is rotated counter-clockwise during the movement of the material 12 (right-to-left) above the build platform 16D. Alternatively, the position of the reels 18A, 18D can be switched, and the reels 18A, 18D can be rotated in the clockwise direction to move the sheet of material 12 left-to-right above the build platform 16D. In still other embodiments, the reels 18A, 18D can be sequentially rotated in the clockwise and counter-clockwise directions to alternately move the sheet of material 12 left-to-right and right-to-left above the build platform 16D.

In this design, the entire material supply assembly 18, including the supply reel 18A; the guide assemblies 18B, 18C; the return reel 18D; and the reel mover assembly 18E are positioned outside of the localized controlled environment. This will simplify the design and control.

In should be noted that the material 12 entering the build chamber 29 can be referred to as the leading edge, while the material 12 exiting the build chamber 29 can be referred to as the trailing edge.

The material thickness 12A of the sheet of material 12 can be varied to suit the manufacturing requirements. In alternative, non-exclusive examples, the material 12 can have a uniform material thickness 12A (along the Z axis) of approximately twenty, thirty, forty, fifty, sixty, seventy, eighty, ninety, one hundred, or two hundred microns. However other material thicknesses 12A are possible.

The measurement device 20 inspects and monitors the melted (fused) layers 14 of the object 11 as that are being built, and/or the deposition of the material layers 14. The number of the measurement devices 20 may be one or plural. For example, the measurement device 20 can measure both before and after the material 12 is cut and/or fused.

As non-exclusive examples, the measurement device 20 may include one or more optical elements such as a uniform illumination device, fringe illumination device (structured illumination device), camera that function at one or more wavelengths, lens, interferometer, or photodetector, or a non-optical measurement device such as an ultrasonic, eddy current, or capacitive sensor.

The energy system 22 selectively generates an energy beam 22A that is directed at a portion of the material 12 above the material bed assembly 16. In the particular embodiment of FIG. 1A, the energy system 22 can be controlled to first cut out the particular material layer 14 from the sheet material 12, and subsequently melt the cut-out layer 14 to sequentially form each of the material layers 14 of the object 11. Alternatively, the cut and melting steps can be reversed. The energy system 22 can selectively cut and melt the material 12 at least based on data regarding to the object 11 to be built. The data may be corresponding to a computer-aided design (CAD) model data. The number of the energy systems 22 may be one or plural.

The design of the energy system 22 can be varied. In one embodiment, the energy system 22 may include one or more energy source(s) (“irradiation systems”) that direct one or more irradiation (energy) beam(s) 22A at the material 12. The one or more energy systems 22 can be controlled to steer and modulate (i.e., turn on and off) the energy beam(s) 22A to cut the material 12 from the roll of material, and the one or more energy systems 22 can be controlled to steer and modulate the energy beam(s) 22A to melt the material 12 to form the object 11.

As alternative, non-exclusives examples, each of the energy sources 22C can be designed to include one or more of the following: (i) an electron beam generator that generates a charged particle electron beam; (ii) an irradiation system that generates an irradiation beam; (iii) an infrared laser that generates an infrared beam; (iv) a mercury lamp; (v) a thermal radiation system; (vi) a visual wavelength system; (vii) a microwave wavelength system; or (viii) an ion beam system.

Different materials 12 have different cutting and melting points. As non-exclusive examples, the desired melting temperature may be at least 1000, 1400, 1700, 2000, or more degrees Celsius.

The housing assembly 24 provides a localized controlled environment (e.g. a localized vacuum environment or an inert atmosphere) around the energy beam 22A so that the energy beam 22A can travel in the controlled environment from the energy system 22 to the material 12. In the simplified implementation of FIG. 1A, the housing assembly 24 is rigid and includes a housing base 24A, and an annular shaped housing side wall assembly 24B that extends downward from a perimeter of the housing base 24A. The measurement device 20 and energy system 22 can be secured to the housing base 24A.

In alternative, non-exclusive implementations, the housing side wall assembly 24B can be circular tube shaped, rectangular tube shaped, polygonal tube shaped, or another suitable configuration.

In the implementation of FIG. 1A, the bottom of housing assembly 24 is spaced apart a material gap 30 from the platform side wall assembly 16B. Further, the material gap 30 can be slightly larger than the material thickness 12A. With this design, the material 12 can be moved in (across) the material gap 30 between the housing assembly 24 and the material bed assembly 16, above the build platform 16A. As non-exclusive examples, the material gap 30 can be less than approximately 1, 2, 5, 10, or 20 percent greater than the material thickness 12A. In some embodiments, a device (not shown) may be included to adjust the material gap 30 depending on the thickness of the material 12 used for each individual built part 11.

Because the material gap 30 is slightly larger than the material thickness 12A, the material 12 in the material gap 30 creates (i) an upper, housing gap 30A between the housing assembly 24 and the material 12; and (ii) a lower, platform gap 30B between the material bed assembly 16 and the material 12. As non-exclusive examples, each gap 30A, 30B can be less than approximately 5, 10, 20, 50, or 100 microns. The gaps 30A, 30B can be the same size or different sizes. In other embodiments, one or both of guide assemblies 18B, 18C may be in contact with a sealing device (not shown) that forms an imperfect environmental seal between guide assemblies 18B, 18C; housing side wall assembly 24B; and material 12.

Alternatively, in other implementations, it is appreciated that the size of the gaps 30A, 30B can be independent of the material thickness 12A of the material 12. For example, in certain non-exclusive alternative embodiments, the size of the gaps 30A, 30B can be less than the material thickness 12A of the material 12.

It should be noted that the guide assemblies 18B, 18C accurately maintain the material 12 spaced apart from the housing assembly 24 and the material bed assembly 16 in the material gap 30, while allowing the material 12 to be moved relative to the build platform 16A and the other components.

With the illustrated design, (i) the housing assembly 24 cooperates with the sheet of material 12 to form a housing chamber 24C above the material 12; and (ii) the build platform 16A, the platform side wall assembly 16B, and the platform seal 16E, cooperate with the sheet of material 12 to form a platform chamber 16F below the material 12. Before the sheet of material 12 is cut, the housing chamber 24C and the platform chamber 16F are separated by the sheet of material 12. Subsequently, when the layer 14 is cut from the sheet of material 12 above the build platform 16A, the housing chamber 24C and the platform chamber 16F are no longer fully separated by the sheet of material 12. It should be noted that in this implementation, the housing chamber 24C and the platform chamber 16F cooperate to form the build chamber 29.

Additionally, the processing machine 10 can include an environmental control assembly 32 (illustrated as a box) that provides a controlled environment in the build chamber 29 (the housing chamber 24C and the platform chamber 16F). Typically, the type of controlled environment will depend on the type of energy system 22. For example, the environmental control assembly 32 can create a vacuum in the build chamber 29. Still alternatively, the environmental control assembly 32 can create a non-vacuum environment such as an inert gas (e.g., nitrogen gas or argon gas) environment in the build chamber 29. The environmental control assembly 32 can include one or more pumps, reservoirs, or other components.

The seal assembly 26 creates (i) a housing seal 26A between the housing assembly 24 and the material 12 to seal the housing gap 30A, while allowing for relative motion between the material 12 and the housing assembly 24; and (ii) a platform seal 26B between the material bed assembly 16 and the material 12 to seal the platform gap 30B, while allowing for relative motion between the material 12 and the material bed assembly 16. The design of each seal 26A, 26B will vary according the desired controlled environment and the type of material 12.

In one embodiment, the bottom of the housing side wall assembly 24B includes a plurality of housing grooves 24D; and the top of the platform side wall assembly 16B includes a plurality of platform grooves 16G. Further, the seal assembly 26 includes a groove environmental controller 26C (illustrated as a box) that (i) controls the environment in the platform grooves 16G to create a leaky platform seal 26B; and (ii) controls the environment in the housing grooves 24D to create a leaky housing seal 26A. The groove environmental controller 26C can include one or more pumps, reservoirs, etc.

For example, if the controlled environment in the build chamber 29 is a vacuum, the groove environmental controller 26C can control the environment in the platform grooves 16G and the housing grooves 24D to be at a vacuum, with the grooves 24D, 16G closest to the build chamber 29 at a higher quality vacuum (i.e., lower pressure) and the grooves 24D, 16G closest to the guide assemblies 18B, 18C at a lower quality vacuum (i.e., higher pressure). Alternatively, if the controlled environment in the build chamber 29 is an inert gas, the groove environmental controller 26C can control the environment in the platform grooves 16G and the housing grooves 24D to be an inert gas. Additionally, to regulate the gap size, and, or to support all or a portion of the weight of housing assembly 24, the groove environmental controller 26C can control the environment in the platform grooves 16G and the housing grooves 24D to be at higher-than-ambient pressure with an inert gas or air.

However, it should be noted that other designs of the seal assembly 26 are possible.

The control system 28 controls the components of the processing machine 10 to build the three-dimensional object 11 from the computer-aided design (CAD) model by successively melting portions of one or more material layers 14. For example, the control system 28 can control (i) the material bed assembly 16; (ii) the material supply assembly 18; (iii) the measurement device 20; and (iv) the energy system 22. The control system 28 can be a distributed system.

The control system 28 may include, for example, a CPU (Central Processing Unit) 28A, a GPU (Graphics Processing Unit) 28B, and electronic memory 28C. The control system 28 functions as a device that controls the operation of the processing machine 10 by the CPU executing the computer program. This computer program is a computer program for causing the control system 28 (for example, a CPU) to perform an operation to be described later to be performed by the control system 28 (that is, to execute it). That is, this computer program is a computer program for making the control system 28 function so that the processing machine 10 will perform the operation to be described later. A computer program executed by the CPU may be recorded in a memory (that is, a recording medium) included in the control system 28, or an arbitrary storage medium built in the control system 28 or externally attachable to the control system 28, for example, a hard disk or a semiconductor memory. Alternatively, the CPU may download a computer program to be executed from a device external to the control system 28 via the network interface. Further, the control system 28 may not be disposed inside the processing machine 10, and may be arranged as a server or the like outside the processing machine 10, for example. In this case, the control system 28 and the processing machine 10 may be connected via a communication line such as a wired communications line (cable communications), a wireless communications line, or a network. In case of physically connecting with wired, it is possible to use serial connection or parallel connection of IEEE1494, RS-232x, RS-422, RS-423, RS-485, USB, etc. or 10BASE-T, 100BASE-TX, 1000BASE-T or the like via a network. Further, when connecting using radio, radio waves such as IEEE 802.1x, OFDM, or the like, radio waves such as Bluetooth (registered trademark), infrared rays, optical communication, and the like may be used. In this case, the control system 28 and the processing machine 10 may be configured to be able to transmit and receive various types of information via a communication line or a network. Further, the control system 28 may be capable of transmitting information such as commands and control parameters to the processing machine 10 via the communication line and the network. The processing machine 10 may include a receiving device (receiver) that receives information such as commands and control parameters from the control system 28 via the communication line or the network. As a recording medium for recording the computer program executed by the CPU, a CD-ROM, a CD-R, a CD-RW, a flexible disk, an MO, a DVD-ROM, a DVD-RAM, a DVD-R, a DVD+R, a DVD-RW, a magnetic medium such as a magnetic disk and a magnetic tape such as DVD+RW and Blu-ray (registered trademark), a semiconductor memory such as an optical disk, a magneto-optical disk, a USB memory, or the like, and a medium capable of storing other programs. In addition to the program stored in the recording medium and distributed, the program includes a form distributed by downloading through a network line such as the Internet. Further, the recording medium includes a device capable of recording a program, for example, a general-purpose or dedicated device mounted in a state in which the program can be executed in the form of software, firmware or the like. Furthermore, each processing and function included in the program may be executed by program software that can be executed by a computer, or processing of each part may be executed by hardware such as a predetermined gate array (FPGA, ASIC) or program software, and a partial hardware module that realizes a part of hardware elements may be implemented in a mixed form.

As provided herein, the processing machine 10 is an additive manufacturing system in which the material 12 in a series of material layers 14 is fused (laminated) together to manufacture the one or more three-dimensional object(s) 11. A non-exclusive discussion on how the processing machine 10 can be used to make the object 11 is provided below. It should be noted that the material layers 14 can be described as a first, second, third, fourth, fifth, etc. material layers 14 moving from the bottom to the top of the built object 11.

For the implementation of FIG. 1A, the material supply assembly 18 is controlled to position the sheet of material 12 above the build platform 16A with the build platform 16A just below the sheet of material 12. At this time, the energy system 22 can be used to cut the first material layer 14 from the sheet of material 12 and the first material layer 14 is now supported by the build platform 16A. The sheet of material 12 can be stationary while the first material layer 14 is cut. Optionally, portions of the first material layer 14 can be heated or melted to firmly attach it to the build platform 16A. Next, the build platform 16A is stepped down (a distance approximately equal to one material layer thickness), and the sheet of material 12 is moved (e.g. by rotating the reels 18A, 18D to move the material from the supply reel 18A to the return reel 18D to place a clean piece of material 12 above the build platform 16A. Subsequently, the motion of material 12 can be stopped, and the energy system 22 is used to cut the second material layer 14 from the sheet of material 12. After this cut, the second material layer 14 is now supported by the build platform 16A above the first material layer 14. Next, the energy system 22 can be controlled to fuse (laminate) the second material layer 14 to the first material layer 14. As described above, these steps can be reversed with the second material layer 14 first fused (welded) to the first material layer 14 and then cut out of the sheet of material 12. Other combinations of cutting and fusing can be used, such as perforating the edge of second material layer 14 and/or spot welding second material layer 14 to first material layer 14. Subsequently, the build platform 16A is stepped down (a distance approximately equal to one material layer thickness), and the sheet of material 12 is moved to place a clean piece of material 12 above the build platform 16A. Next, the material 12 can be stopped, and the energy system 22 is used to cut the third material layer 14 from the sheet of material 12. After this cut, the third material layer 14 is now supported by the build platform 16A above the second material layer 14. Next, the energy system 22 can be controlled to fuse the third material layer 14 to the second material layer 14. This process is repeated for each subsequent material layer 14 until the object 11 is completely built.

It should be noted that each material layer 14 is specifically cut to match the desired shape of the object 11 at that level. Depending on the shape of the object 11, additional portions of material 12 may be cut and fused to form a support structure that supports overhanging features or other portions of the object 11. The support structure may provide any or all of support against gravity, support against thermal deformation, improved thermal conductivity, and improved electrical conductivity.

With this design, each three-dimensional object 11 is formed through consecutive fusions (lamination) of consecutively formed cross sections (layers 14) of material 12. This process is sometimes referred to Layered Object Manufacturing (LOM). For simplicity, the example of FIG. 1A illustrates only a few, separate, stacked material layers 14. However, it should be noted that depending upon the design of the object 11, the building process will require numerous (e.g., hundreds or thousands) material layers 14.

It should be noted that in the design of FIG. 1A, many of the components are positioned outside the controlled environment in the build chamber 29. For example, the material supply assembly 18 and the platform mover 16D are positioned outside the controlled environment of the build chamber 29. This will simplify the design, operation, and servicing of these components.

FIG. 1B is a top view of portion of the sheet of material 12 after three material layers (not shown in FIG. 1B) have been cut out at different times. More specifically, in FIG. 1B, a rectangular cut (hole) 12B was made to generate a rectangular shaped material layer that was positioned on the build platform 16A (illustrated in FIG. 1A). Next, the sheet of material 12 was moved and a circular cut 12C was made to generate a circular shaped material layer that was positioned on the previous layer. Subsequently, the sheet of material 12 was moved and a polygonal cut 12C was made to generate a polygonal shaped material layer that was positioned on the previous layer.

It should be noted that the shape of each cut and corresponding material layer will depend on the design of the object 11 (illustrated in FIG. 1A), and that the shapes illustrated in FIG. 1B are merely non-exclusive examples of possible cuts.

Further, FIG. 1B illustrates that sheet of material 12 can have sheet width 12E. As non-exclusive examples, the sheet width 12E is approximately 50, 100, 200, 300, 400, 500, 600 or 1000 millimeters.

With reference to FIGS. 1A and 1B, it should also be noted that holes 12B, 12C, 12D in the sheet of material 12 can influence the operation of the seal assembly 26 on the trailing edge (material exiting the build chamber 29) because the cuts in the material 12 provide an open flow path between the housing assembly 24 and the material bed assembly 16. In one embodiment, the seal assembly 26 has a seal length 26D (illustrated in FIG. 1A) that is longer than a cut length 12F (illustrated in FIG. 1B) of the longest cut in the material 12. With this design, there is always a portion of the material 12 between the housing assembly 24 and the material bed assembly 16 at all locations.

As a specific, non-exclusive example, the longest cut length 12F can be approximately two hundred millimeters, and the seal length 26D can be three hundred millimeters. As alternative, non-exclusive examples, the seal length 26D can be at least ten, twenty, fifty, one hundred or two hundred percent longer than the longest cut length 12F to maintain the seal. It should be noted that the processing machine 10 is designed to form an object 11 having a maximum size (e.g. a maximum length 11A or maximum width). Thus, the processing machine 10 can be designed so that the seal length 26D is longer (e.g. at least ten, twenty, fifty, one hundred or two hundred percent longer) than the maximum length 11A of the object 11.

FIG. 1C is a bottom view of the housing assembly 24 including the housing base 24A, the housing side wall assembly 24B, and the housing grooves 24D. In this non-exclusive example, the housing assembly 24 is rectangular shaped. In this design, the trailing edge of the housing assembly includes a plurality of additional grooves 24D1, 24D2, and 24D3 in the side wall assembly 24B to extend the seal length at the trailing edge.

FIG. 1D is a top view of the material bed assembly 16 including the build platform 16A, the platform side wall assembly 16B, the platform seal 16E, and the platform grooves 16G. In this non-exclusive example, the material bed assembly 16 is rectangular shaped. In this design, the trailing edge of the material bed assembly 16 includes a plurality of additional grooves 16G1, 16G2, and 16G3 in the side wall assembly 16B to extend the seal length at the trailing edge.

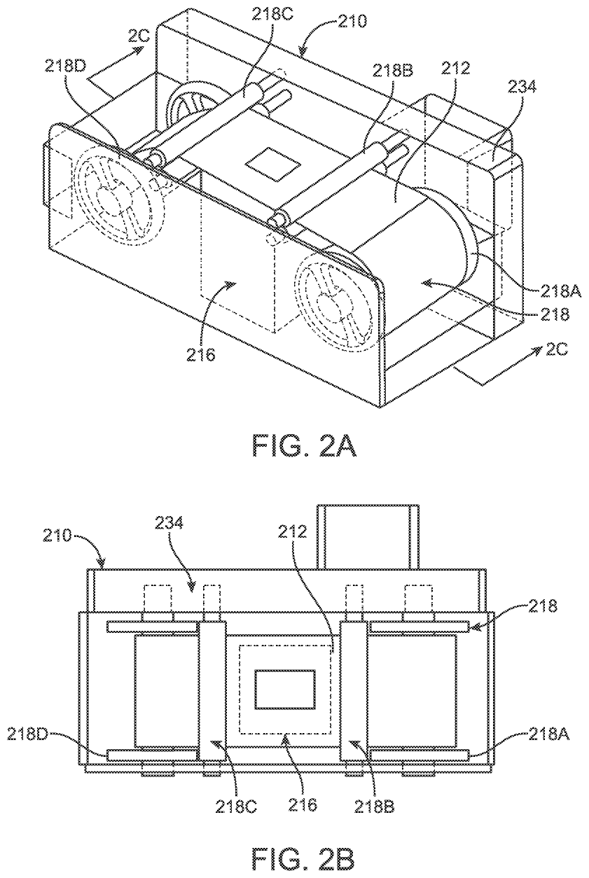

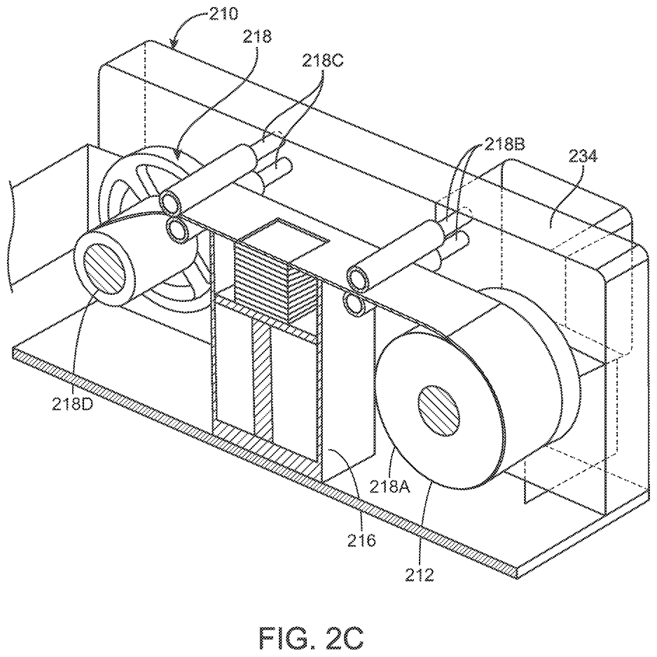

FIG. 2A is a perspective view, and FIG. 2B is a top view of a portion of another implementation of the processing machine 210, including the material bed assembly 216 and material supply assembly 218 that are somewhat similar to the corresponding components described above. Further, FIG. 2C is a cut-away view taken on line 2C-2C in FIG. 2A.

In this design, the material supply assembly 218 includes (i) the supply reel 218A; (ii) the input material guide assembly 218B; (iii) the output material guide assembly 218C; (iv) the return reel 218D; and (v) the reel mover assembly (not shown in FIGS. 2A-2C) that cooperate to position the material 212 on (or above) the material bed assembly 216.

Further, in this embodiment, the processing machine 210 includes a rigid support frame 234 that supports the material bed assembly 216 and material supply assembly 218.

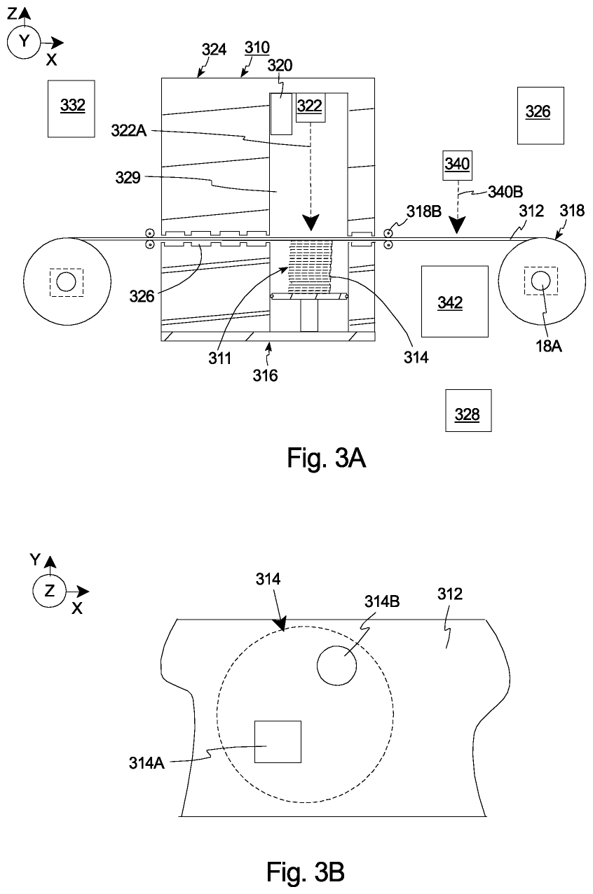

FIG. 3A is a simplified, cut-away view of another implementation of a processing machine 310 that includes (i) a material bed assembly 316; (ii) a material supply assembly 318; (iii) a measurement device 320; (iv) an energy system 322 that generates an energy beam 322A; (v) a housing assembly 324; (vi) a seal assembly 326; (vii) a control system 328; and (viii) an environmental control assembly 332 that are similar to the corresponding components described above and illustrated in FIG. 1A. In this design, the processing machine 310 is again designed to utilize a localized controlled environment in the build chamber 329 for the energy beam 322A to travel from the energy system 322 to the material 312.

However, in the implementation of FIG. 3A, the energy system 322 additionally includes a cutting system 340 that selectively cuts the sheet of material 312 outside of (e.g. prior to the material entering) the build chamber 329. For example, the cutting system 340 can cut the sheet of material 312 between the supply reel 318A and the input guide assembly 318B. Alternatively, the cutting system 340 can be located in another position outside of the build chamber 329. In other embodiments, the cutting system 340 can be placed inside the build chamber 329 between the leading edge and the trailing edge of the material 312.

FIG. 3B is a top view of a portion of sheet of material 312 with a circular shaped material layer 314 illustrated in phantom. With reference to FIGS. 3A and 3B, the material layer 314 is illustrated in phantom in FIG. 3B to represent that sheet of material 312 has not yet been cut with the energy beam 322A in the build chamber 329. In this non-exclusive example, the cutting system 340 has cut a rectangular shape passageway 314A, and a circular shaped passageway 314B in the sheet of material 312 prior to entry into the build chamber 329. However, the passageways 314A, 314B can have any other configuration (i.e., shape and/or number).

Depending upon the design of the object 311, it can include one or more internal passageways. In these instances, the one or more internal passageways 314A, 314B can be cut into each of the (future) material layers 314 by the cutting system 340 prior to entry into the build chamber 329. It should be noted that if the object 311 has a nested passageway configuration that the material 312 may have to have some internal passageways 314A, 314B cut and the material 312 subsequently moved to the build chamber 329 for fusing. Next, the remaining material 312 can be moved back (reversed by the rotating the supply 318A) to cut more additional passageways (not shown) with the cutting system 340, and subsequently advanced to the build chamber 329. This process can be repeated as necessary to achieve the nested configuration of each material layer 314.

Because, the cutting system 340 is located outside of the build chamber 329 (and outside of the locally controlled environment), this allows for a wider range of possible cutting systems 340. For example, the cutting system 340 can be (i) an irradiation system that generates an irradiation beam; (ii) an infrared laser that generates an infrared beam; or (iii) a plasma torch.

In FIG. 3A, the cutting system 340 is a laser that directs a cutting beam 340A that cuts the passageways 314A, 314B outside the build chamber 329.

Additionally, in FIG. 3A, the cutting system 340 can includes a scrap receptacle 342 to capture scrap material cut from the sheet of material 312.

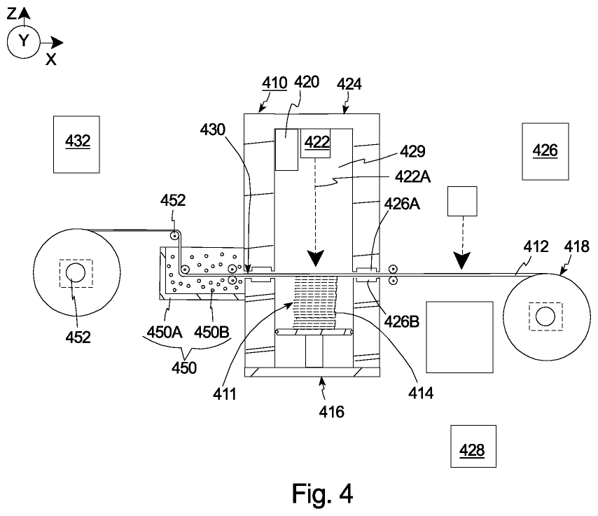

FIG. 4 is a simplified, cut-away view of still another implementation of a processing machine 410 that includes (i) a material bed assembly 416; (ii) a material supply assembly 418; (iii) a measurement device 420; (iv) an energy system 422 that generates an energy beam 422A; (v) a housing assembly 424; (vi) a seal assembly 426; (vii) a control system 428; and (viii) an environmental control assembly 432. In this embodiment, the material bed assembly 416, the measurement device 420, the energy system 422; the housing assembly 424, the control system 428, and the environmental control assembly 432 are similar to the corresponding components described above and illustrated in FIG. 1A. In this design, the processing machine 410 is again designed to utilize a localized controlled environment in the build chamber 429 for the energy beam 422A to travel from the energy system 422 to the material 412.

However, in the implementation of FIG. 4, the seal assembly 426 and the material supply assembly 418 are slightly different. In this design, instead of a long housing seal 426A and platform seal 426B on the trailing edge for the material 412 exiting the build chamber 429, the seal assembly 426 includes a liquid bath 450 positioned over the gap 430 at the trailing edge where the scrap sheet of material 412 exits the material gap 430. With this design, the liquid bath 450 will seal the material gap 430 even though the sheet of material 412 includes the cuts.

In this design, the liquid bath 450 can include a reservoir 450A that is filled with a liquid 450B (illustrated with small circles) to form an amorphous seal. For example, the liquid 450B can be a liquid metal or an oil that has a relatively high surface tension so that the liquid 450B is not pulled into the material gap 430.

It should be noted that the material supply assembly 418 can include one or more additional rollers 418D for directing the scrap sheet of metal 412 through the liquid bath 450 and to the return reel 418D.

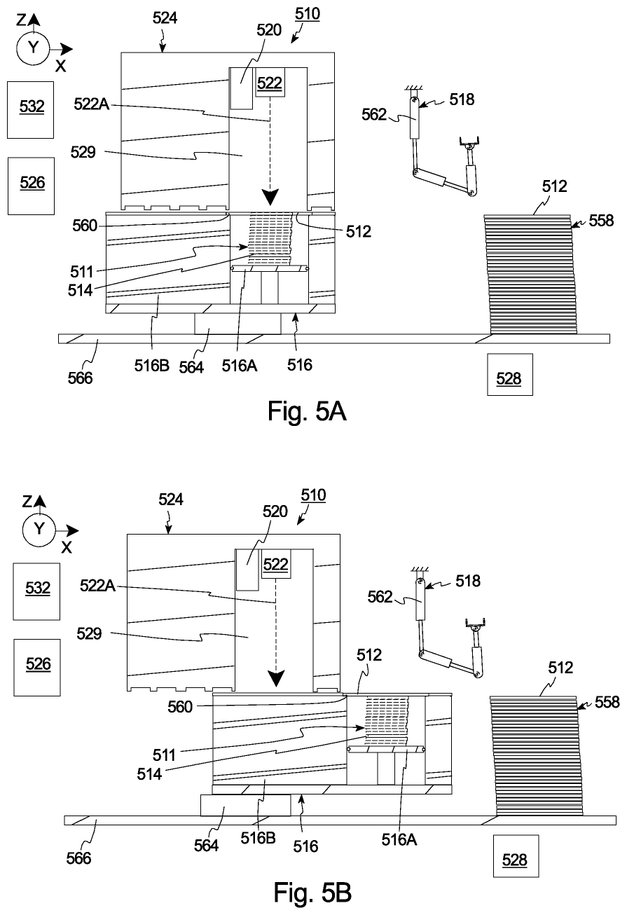

FIGS. 5A and 5B are alternative, simplified, cut-away views of still another implementation of a processing machine 510 that includes (i) a material bed assembly 516; (ii) a material supply assembly 518; (iii) a measurement device 520; (iv) an energy system 522 that generates an energy beam 522A; (v) a housing assembly 524; (vi) a seal assembly 526; (vii) a control system 528; and (viii) an environmental control assembly 532. In this implantation, the measurement device 520, the energy system 522, the housing assembly 524, the seal assembly 526, the control system 528, and the environmental control assembly 532 are somewhat similar to the corresponding components described above and illustrated in FIG. 1A. In this design, the processing machine 510 is again designed to utilize a localized controlled environment in the build chamber 529 for the energy beam 522A to travel from the energy system 522 to the material 512.

However, in the implementation of FIGS. 5A and 5B, the material supply assembly 518 and the material bed assembly 516 are slightly different. In this design, the material 512 is provided as individual sheets of material 512, instead of as a roll of material. For example, the material 512 can be provided as a stack 558 of individual flat plates of material 512. The shape of the flat plates can be varied. As alternative, non-exclusive examples, each flat plate can be rectangular, circular, or polygonal shaped.

Further, in this implementation, the platform side wall assembly 516B includes a recess 560 for selectively receiving and retaining an individual sheet of material 512 above the build platform 516A. Thus, the size and shape of the recess 560 will correspond to the size and shape of the individual sheets of material 512. Moreover, the material supply assembly 518 can includes a sheet mover 562 that selectively removes used sheets, and adds new material sheets 518 from the stack of flat plates 558 to the material bed assembly 516. For example, the sheet mover 562 can include one or more robotic arm(s) that are controlled by the control system 528.

Additionally, the processing machine 510 can include an actuator system 564 that causes relative movement between the material bed assembly 516 and the housing assembly 524. For example, comparing FIGS. 5A and 5B, in this implementation, the actuator system 564 moves the material bed assembly 516 relative to the housing assembly 524 and a base 566. Alternatively, the actuator system 564 could be designed to move the housing assembly 524 relative to the material bed assembly 516. With these designs, the actuator system 564 can be controlled to move the material 512 to the build chamber 529 (illustrated in FIG. 5A) for processing, or away from the build chamber 529 (illustrated in FIG. 5B) so that the sheet material 512 can be removed and replaced with new material 512 via the sheet mover 562. For example, the actuator system 564 can include one or more linear guides, one or more linear motors, one or more rotary motors and/or another type of conveyor assembly.

In this design, the material supply assembly 518 is positioned outside of the build chamber 529.

For each material layer 514, the sheet of material 512 is positioned over the build platform 516A (and the portion of the object 511 that has already been built). Subsequently, the actuator system 564 positions the material bed assembly 516 inside the build chamber 529. The perimeter of this material layer 514 can be cut by the energy beam 522A and the desired portion can be fused (welded) to the object 511.

Additionally, the processing machine 510 can include a cutting system 340 (illustrated in FIG. 3A) that is positioned outside of the build chamber 529. The cutting system 340 can be used to cut one or more passageways 314A, 314B (illustrated in FIG. 3B) in the sheet of material 512 outside of the build chamber 529 for objects 511 having one or more internal passageways. In some designs, the sheet of material 512 can move repeatedly back and forth between the build chamber 529 and the cutting system 340 outside the build chamber 520 to build an object 511 having a complex geometry.

Alternatively, the internal passageways can be cut with the energy beam 522A inside the build chamber 529, and the sheet mover 562 (e.g. the robotic arm) can be used to remove the scrap material outside of the build chamber 529. In further alternative embodiments, an additional robotic arm (not shown) located inside the build chamber 529 can be used to remove the scrap material inside the build chamber 529.

It should be noted that in the implementation of FIGS. 5A and 5B, the seal assembly 526 seals the housing assembly 524 to the material bed assembly 516 and/or the sheet of material 512. More specifically, when the sheet of material 512 is positioned in the build chamber 529 (illustrated in FIG. 5A), the seal assembly 526 seals the housing assembly 524 to the top of the platform side wall assembly 516B. Similarly, when the sheet of material 512 is positioned outside of the build chamber 529 (illustrated in FIG. 5B), the seal assembly 526 again seals the housing assembly 524 to the top of the platform side wall assembly 516B. However, during the transition between the positions illustrated in FIGS. 5A and 5B, the seal assembly 526 seals the housing assembly 524 to the sheet of material 512 in addition to the top of the platform side wall assembly 516B.

Further, it should be noted that the housing assembly 524 and the platform side wall assembly 516B can be designed to allow for the controlled environment in the build chamber 529 to be maintained as the sheet of material 512 is moved between the two positions illustrated in FIGS. 5A and 5B. In some embodiments, during the transition between the positions illustrated in FIGS. 5A and 5B, the seal provided by seal assembly 526 may leak at a higher rate than normal, degrading the quality of the controlled environment in the build chamber 529. In these embodiments the environmental control assembly 532 is designed to accommodate this intermittent high leak rate and return the controlled environment in the build chamber 529 to the desired state before cutting and melting with energy beam 522A begins.

In the implementations that cut the sheet of material 12, 312, 412, 512, to create the material layers 14, 314, 414, 514, these material layers 14, 314, 414, 514 can be “tack welded” at selective locations during the lamination process. By minimizing the welding operations, heat input and thermal deformation of the object are reduced while throughput is maximized. Subsequently, the fully-assembled object can be heated into a full-density solid object by heat treatment in a furnace or Hot Isostatic Press processing.

Alternatively, each of the material layers 14, 314, 414, 514 can be fully melted when each layer 14, 314, 414, 514 is positioned on the build platform.

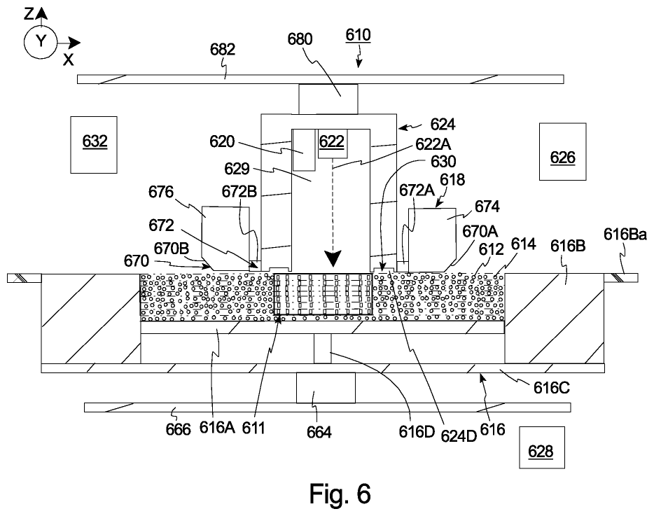

FIG. 6 is a simplified, cut-away view of still another implementation of a processing machine 610. In this design, the processing machine 610 includes (i) a material bed assembly 616; (ii) a material supply assembly 618; (iii) a measurement device 620; (iv) an energy system 622 that generates an energy beam 622A; (v) a housing assembly 624; (vi) a seal assembly 626; (vii) a control system 628; and (viii) an environmental control assembly 632. In this implantation, the energy system 622, the control system 628, and the environmental control assembly 632 are somewhat similar to the corresponding components described above and illustrated in FIG. 3A.

In FIG. 6, the processing machine 610 is again designed to utilize a localized controlled environment in the build chamber 629 for the energy beam 622A to travel from the energy system 622 to the material 612. Further, in FIG. 6, the measured device 620 is illustrated inside the build chamber 629. Alternatively, one or more measurement devices 620 can be located outside of the build chamber 629.

In the implementation of FIG. 6, the material 612 is a powder (e.g. a metal powder) that is deposited onto the build platform 626B in a series of powder layers 614. Further, the material bed assembly 616; the material supply assembly 618; and the seal assembly 626 are slightly different from the corresponding systems described above. Moreover, the processing machine 610 can additionally include (i) a rake system 670 that levels and distributes the material 612 on the build platform 616A; and (ii) a thermal control system 672 which adjusts the temperature of the material 612 outside of and near the build chamber 629.

With the design in FIG. 6, the problem of building objects 611 with an electron beam energy system 622 is solved by keeping the material bed assembly 616 and the material supply assembly 618 in atmosphere (or different environment from the build chamber 629) and having a local vacuum build chamber 629 around the electron-beam exposure area. For example, in the implementation of FIG. 6, the build platform 616A supporting the object 611, and the material supply assembly 618 can be at an atmospheric environment (or other environment) from the build chamber 629. The atmosphere may be air, helium, dry nitrogen, or another gas. The electron beam 622A is projected from above and travels through a vacuum system. The area of the powder 612 exposed to the vacuum environment 629 may be small, for example on the order of 10 to 50 mm. The vacuum chamber 629 will have a small hole (or multiple holes in the case of a multi-beam system) at the bottom that allows the electron beam 622A to reach and melt the material 612.

It should be noted that in FIG. 6, the platform side wall assembly 616B can be wider to allow for the vacuum to be maintained when the build chamber 629 is near the edges of the platform side wall assembly 616B. Additionally, or alternatively, one or more flanges 616Ba (only one is shown) can be added to or near the platform side wall assembly 616B. The one or more flanges 616Ba form a horizontal surface around the platform side wall assembly 616B to allow for the vacuum to be maintained when the build chamber 629 is near the edges of the platform side wall assembly 616B at extreme left and right relative positions.

Moreover, the non-exclusive design in FIG. 6 integrates powder deposition, raking, pre-heating, energy beam melting, and cooling of the melted object 611. Further, in FIG. 6, there is relative motion between the build chamber 629 and the material bed assembly 616.

The material bed assembly 616 supports the powder material 612 during the forming of the object 611. In FIG. 6, the material bed assembly 616 includes the build platform 616A, the platform side wall assembly 616B, the platform base 616C, and the platform mover 616D that are similar to the corresponding component described above. With this design, the build platform 616A can be moved linearly downward relative to the platform side wall assembly 616B with the platform mover 616D as each subsequent powder layer 614 is added.

The material supply assembly 618 is designed to deposit the powder material 612 in the series of layers 614 that are sequentially fused together by the energy beam 622A. Handling of the powder in vacuum is complicated and makes the size and design of the vacuum system more difficult. In the present design, the material supply assembly 618 is located outside of the build chamber 629 and thus is easier to design and operate.

In the non-exclusive implementation of FIG. 6, the material supply assembly 618 is a top-down, gravity driven system that includes a first container 674 and a second container 676 which are spaced apart and located on opposite sides of the build chamber 629. In FIG. 6, the first container 674 is on the right and the second container 676 is on the left. Moreover, each container 674 can retain the supply of powder material 612 prior to dispensing onto the build platform 616A. Further, each container 674, 676 can include a dispenser (not shown) which controls the flow of the powder material 612 from the respective container 674, 676. However, other designs of the material supply assembly 618 are possible.

Further, in FIG. 6, the rake system 670 can be integrated into the container 674, 676. For example, the rake system 670 can include a first rake 670A that is integrated into the first container 674, and a second rake 670B that is integrated into the second container 676.

With this design, at the bottom of each container 674, 676 includes a dispenser and a raking mechanism 670A, 670B. Together these mechanisms work to dispense the proper amount of powder material 612, compact it to a desired density, and spread it to form a flat material layer 614.

The thickness of each material layer 614 can be varied to suit the manufacturing requirements. In alternative, non-exclusive examples, one or more (e.g. all) of the material layers 614 can have a uniform layer thickness (along the Z axis) of approximately twenty, thirty, forty, fifty, sixty, seventy, eighty, ninety, one hundred, two hundred, or four hundred microns. However other layer thicknesses are possible. Particle sizes of the powder 612 can be varied. In one implementation, a common particle size is approximately fifty microns. Alternatively, in other non-exclusive examples, the average particle size can be approximately twenty, thirty, forty, sixty, seventy, eighty, ninety, one hundred, two hundred, or four hundred microns.

With the present design, the material supply assembly 618 deposits the material 612 onto the build platform 616A to sequentially form each material layer 614. Once a portion of the material layer 614 has been melted with the energy system 622, the material supply assembly 618 evenly and uniformly deposits another (subsequent) material layer 614. In this implementation, each three-dimensional object 611 is formed through consecutive fusions of consecutively formed cross sections of material 612 in one or more material layers 614.

The thermal control system 672 adjusts the temperature of the material 612 outside of the build chamber 629. In the non-exclusive implementation of FIG. 6, the thermal control system 672 includes a first thermal controller 672A and a second thermal controller 672B which are spaced apart and located on opposite sides of the build chamber 629. In FIG. 6, the first thermal controller 672A is on the right of the build platform 629, and the second thermal controller 672B is on the left of the build platform 629. Each thermal controller 672A, 672B can include one or more heaters or chillers, and each thermal controller 672A, 672B can adjust the temperature of the powder material 612 by radiation, convection, or conduction.

With this design, the thermal control system 672 can be controlled to sinter the powder material 612 before entering the build chamber 629, and/or cool the melted material 612 exiting the build chamber 629.

Because the electron beam 622A uses a stream of charged particles (electrons) to melt the powder material 612, the individual particles can develop a charge and repulse each other. When the charge is large enough, the particles develop enough repulsive force to overcome gravity and fly apart. This phenomenon has many names including powder ‘smoking’ and powder ‘spreading’.

Sintering the powder material 612 prior to entry into the build chamber 629 with the thermal control system 672 lightly fuses the material 612 together. In this implementation, the powder material 612 of each powder layer 614 is sintered to barely melt the powder 612 prior to entering into the build chamber 629. The sintered powder 612 has not melted enough to be structurally strong, but it has melted enough to stick together and to increase its electrical conductivity. It is this slight melting that keeps the powder 612 from flying apart when the energy beam 622A subsequently melts the powder 612. For each powder layer 614, once it is sintered together, the electron beam 622A can be controlled to melt the desired regions of the powder layer 614 to form a portion of the object 611.

Further, because the sintered material 612 is locked together, it will better stay together when it is subjected to the pressure differential between (i) vacuum in the gap 630 and the build chamber 629 and (ii) the atmosphere outside the build chamber 629.

The temperature required to sinter the powder 612 will vary according to the type of powder. The desired sinter temperature may be 50% 75% 90% or 95% of the melting temperature of the powder material 612. It is understood that different powders have different melting points and therefore different sintering points. As non-exclusive examples, the desired preheated temperature may be at least 300, 500, 700, 900, or 1000 degrees Celsius.

Additionally, the time required to sinter the powder 612 can also be varied, as it is appreciated that the desired sintering of the powder 612 is a factor of both temperature and time. For example, in certain non-exclusive embodiments, the sintering time can be approximately 5, 10, 15, 20 or 30 seconds depending on the sinter temperature and the type of powder 612 used.

In one implementation, the bottom surface of the housing assembly 624 may be in direct contact with the powder material 612, or may be maintained the small gap 630 (e.g. approximately five, ten or fifteen microns as non-exclusive examples) from the powder material 612 on the build platform 616A. The seal assembly 626 seals the gap 630 between the housing assembly 424 and the powder 612. The housing assembly 624 can again include one or more concentric housing grooves 624D which are maintained at a rough vacuum by the seal assembly 626. The horizontal bottom surface of the housing assembly 624 facing the powder material 612 should be wide enough to limit atmosphere leakage into the controlled environment of the build chamber 629.

As provided above, in FIG. 6, there is relative motion between the build chamber 629 and the material bed assembly 616. In one design, the processing machine 610 includes an actuator system 664 that moves the material bed assembly 616 relative to the material supply assembly 618, the thermal control system 672, the build chamber 629, the housing assembly 624, and the lower base 666. Alternatively, or additionally, the processing machine 610 can include an upper actuator system 680 that moves the build chamber 629, the housing assembly 624, the material supply assembly 618, and the thermal control system 672 relative to an upper base 682, the material bed assembly 616, and the lower base 666.

For example, each actuator system 664, 680 can include one or more linear, or rotary actuators.

The goal of this implementation is to allow simultaneous operation of powder deposition, temperature control (both before and after melting), and energy beam melting, all in a single pass of the print system relative to the build platform 616A.

As shown in this figure, the processing of one layer begins with the build platform 616A at an extreme left position. Either the material bed assembly 616 or the build chamber 629 can be moved while the other is stationary. In some embodiments it may be preferable to have both systems move in opposite directions.

In one example, first, the build platform 616A is accelerated to the right by the actuator system 664. As the right edge of the build platform 616A passes the second container 676, powder 612 is dispensed in a new layer. As the new powder 612 passes under the second thermal controller 672B, the powder 612 is sintered. When the sintered powder 612 passes into the build chamber 629, it is exposed by the energy beam 622A, selectively melting the powder 612 into the desired shape. The partially melted part then passes under the first thermal controller 672A where excess heat is removed and the part is cooled to an appropriate temperature. The first container 674 is inactive during fabrication of this layer 614. After the build platform 616A has moved past the first container 674, it is decelerated to a stop. Then the process repeats with the next layer while the build platform 616A moves from right to left.

It is understood that although a number of different embodiments of the processing machine have been illustrated and described herein, one or more features of any one embodiment can be combined with one or more features of one or more of the other embodiments, provided that such combination satisfies the intent of the present disclosure.

While a number of exemplary aspects and embodiments of the processing machine 10 have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A processing machine for building a three-dimensional object from material, the processing machine comprising:
a material bed assembly that supports the material during building of the object;
a material supply assembly that positions the material;
an energy system that directs an energy beam at the material to build a portion of the object on the material bed assembly;
a housing assembly that defines a localized controlled environment for the energy beam; and
an environmental control assembly that controls the localized controlled environment for the energy beam.

2. The processing machine of claim 1, wherein the housing assembly defines the localized controlled environment on at least part of the material.

3. The processing machine of claim 1 wherein the housing assembly is spaced apart a housing gap from at least one of the material and the material bed assembly; and further comprising a seal assembly that creates a housing seal to seal the housing gap.

4. The processing machine of claim 3 wherein the housing seal is a leaky seal.

5. The processing machine of claim 3 wherein the seal assembly includes a seal environmental controller that controls a housing gap environment in the housing gap.

6. The processing machine of claim 1 wherein the environmental control assembly controls the localized controlled environment to be at a vacuum.

7. The processing machine of claim 6 wherein the seal assembly includes a seal environmental controller that creates a vacuum in the housing gap.

8. The processing machine of claim 1 wherein the environmental control assembly controls the localized controlled environment to be an inert atmosphere.

9. The processing machine of claim 8 wherein the seal assembly includes a seal environmental controller that creates a partially inert atmosphere in the housing gap that is a mixture of the ambient atmosphere outside the machine and the inert atmosphere.

10. The processing machine of claim 1 wherein the material supply assembly supplies a sheet of material to the material bed assembly.

11. The processing machine of claim 10 wherein the material supply assembly includes a supply reel that initially retains the sheet of material, and a return reel; wherein, movement of the supply reel causes the sheet of material to move above the material bed assembly to the return reel.

12. The processing machine of claim 10 wherein the energy system directs the energy beam at the material above the material bed assembly to cut and melt the sheet of material.

13. The processing machine of claim 10 further comprising a cutting system that cuts out a passageway in the sheet of material prior to this portion of the sheet of material being positioned in the build chamber.

14. The processing machine of claim 10 wherein the material is a sheet of material, wherein the energy system cuts a material layer from the sheet of material to create a cut in the sheet of material, and wherein the housing seal includes a seal length that is bigger than a cut length of the cut.

15. The processing machine of claim 1 wherein at least a portion of the material supply assembly is positioned outside of the localized controlled environment.

16. The processing machine of claim 1 wherein the material supply assembly positions the material between the housing assembly and the material bed assembly.

17. The processing machine of claim 16 wherein the seal assembly creates a bed seal between the material bed assembly and the material.

18. The processing machine of claim 1 wherein the material supply assembly deposits a powder layer of powder onto the material bed assembly.

19. The processing machine of claim 18 further comprising a thermal control system which sinters the powder prior to the powder being positioned in the build chamber.

20. The processing machine of claim 19 wherein the thermal control system is positioned outside the build chamber.

21. A method for building a three-dimensional object from material comprising:
supporting the material with a material bed assembly during building of the object;
positioning the material with a material supply assembly;
directing an energy beam at the material to build a portion of the object on the material bed assembly with an energy system;
providing a build chamber for the energy beam with a housing assembly; and
creating a localized controlled environment in the build chamber for the energy beam with an environmental control assembly.
